(19) United States
(12) Patent Application Publication
(10) Pub. No.: US 2015/0012409 A1
(43) Pub. Date: Jan. 8, 2015

(54) METHOD AND SYSTEM FOR FACILITATING A CROSS-CURRENCY TRANSACTION

(71) Applicant: Toft ApS, Copenhagen (DK)

(72) Inventor: Jesper Toft, Gentofte (DK)

(21) Appl. No.: 14/322,967

(22) Filed: Jul. 3, 2014

Related U.S. Application Data
(60) Provisional application No. 61/843,120, filed on Jul. 5, 2013.

(51) Int. Cl. G06Q 20/38

(52) U.S. Cl. CPC G06Q 20/381; G06Q 40/04
USPC 705/37

(57) ABSTRACT

A method and a system for facilitating a transaction between a first party and a second party, the first party operating in a first currency, the second party operating in a second currency different from the first currency are provided. The method includes receiving, at a host computer system, transaction information, the transaction information comprising at least a transaction amount in an agreed settlement unit and a first date. The agreed settlement unit is the first currency, the second currency, an intermediate currency or an intermediate settlement unit. The method further has a step of receiving at least one agreed settlement unit exchange rate at the first date; and computing a settlement amount in the agreed settlement unit based on a plurality of transaction parameters and an apportionment method.

### CROSS-REFERENCE TO RELATED APPLICATION

This application claims the benefit of U.S. Provisional Patent Application No. 61/843,120, filed on Jul. 5, 2013, the contents of which are incorporated herein by reference in their entirety.

### TECHNICAL FIELD

The present invention generally relates to a cross-currency transaction method and a system to perform such transactions.

### BACKGROUND OF THE INVENTION

In the current economy, business transactions often take place between partners operating in different currencies. These transactions are typically performed in one or the other partner's operating currency or alternatively in a third intermediate currency. However the currency market is such that most currencies are subject to fluctuations, resulting in varying exchange rates between the two distinct currencies. The transaction amounts converted in a given currency at the time of agreement are often not the same when converted in the same currency at a later time of settlement. Such fluctuations make cross-currency transactions usually favourable or unfavourable to one of the business partners or to both of them. Business partners are thus exposed to a financial risk posed by unanticipated changes in the exchange rate between currencies. This is also known as currency risk, Foreign exchange risk or exchange rate risk. If the transaction takes place directly without using an intermediate currency, one of the business partners usually bears alone the entire currency risk. If the transaction takes place using an intermediate currency, then both partners bear alone the currency risk towards the intermediate currency. There is accordingly a need for mitigating the currency risk in cross-currency transactions for each partner.

### SUMMARY OF INVENTION

It is an object of the present invention to provide a method and a system that overcome at least some of the drawbacks as mentioned above

According to a first aspect of the invention a method for facilitating a transaction between a first party and a second party is provided, the first party operating in a first currency, the second party operating in a second currency different from the first currency, the method comprises receiving, at a host computer system, transaction information, the transaction information comprising at least a transaction amount in an agreed settlement unit and a first date. The agreed settlement unit is being selected from a group consisting of the first currency, the second currency, an intermediate currency and an intermediate settlement unit. The method further comprises a step of receiving, at the host computer system, from at least one provider at least one agreed settlement unit exchange rate at the first date; and computing, on the host computer system, a settlement amount in the agreed settlement unit based on a plurality of transaction parameters and an apportionment method. The transaction parameters comprise the transaction information, the exchange rate between the agreed settlement unit and the first and/or second currency at the first date, a fluctuation of the exchange rate between the agreed settlement unit and the first and/or second currency between the first date and a second date. The apportionment method is pre-determined to allocate to each party a share of a difference in the transaction amount between the first date and the second date resulting from the fluctuation of the exchange rate. The share of the difference in the transaction amount may be predetermined e.g. a 50% for each party. Alternatively, the share may be determined using a predetermined method e.g. a predetermined method taking into account the respective movement of the first currency and the second currency relative to the settlement unit. Thus, if the movement of the first currency relative to the settlement unit is larger than the movement of the second currency relative to the settlement unit, the apportionment method may allocate to the first party a proportional larger share of the difference in the transaction amount than the share allocated to the second party.

Consequently, by determining a settlement amount different from the transaction amount, where the settlement amount is dependent on the movements of the first currency and the second currency, the currency risk for the first party and the second party may be mitigated.

It is thus understood that if the transaction is direct without using an intermediate currency or an intermediate settlement unit, the agreed settlement unit is selected from a group consisting of the first currency and the second currency. If the agreed settlement unit is the first currency, the agreed settlement unit exchange rate is the exchange rate between the first currency and the second currency, or vice versa.

Accordingly, if the agreed settlement unit is an intermediate currency or an intermediate settlement unit, then an agreed settlement unit exchange rate is determined between the agreed settlement unit and the first currency and between the agreed settlement unit and the second currency.

In one or more embodiments, a communication system may allow one or both parties to remotely perform the first aspect of the invention thereby facilitating settlement amounts in cross-currency transactions.

It is an advantage that the risk imposed on one or both parties of a transaction by the fluctuation of the currency exchange rate is divided or split by sharing the risk between the parties. This may allow more flexibility in terms of agreements, i.e. it is possible to specify all the parameters in the trade.

In a second aspect, a system facilitating a transaction between a first party and a second party, such as between a computing device of a first party and a computing device of a second party, is provided. The first party is operating in a first currency and the second party is operating in a second currency different from the first currency. The system may comprise an interface adapted to receive transaction information, the transaction information comprising at least a transaction amount in an agreed settlement unit and a first date, the agreed settlement unit being selected from a group consisting of the first currency, the second currency, an intermediate currency and an intermediate settlement unit. The system may further comprise a database adapted to receive from at least one provider at least one agreed settlement unit exchange rate at the first date and to store the received exchange rate; a control unit adapted to compute a settlement amount in the agreed settlement unit based on a plurality of transaction parameters, the transaction parameters comprising the transaction amount in the agreed settlement unit at the first date, the agreed settlement unit exchange rate at the first date, a fluctuation of the exchange rate between the agreed settlement unit and the first and/or second currency between the first date and a second date, and an apportionment method. The apportionment method is pre-determined by the first party and/or the second party and the method may allocate to each party a share of a difference in the transaction amount between the first date and the second date resulting from the fluctuation of the exchange rate.

The different elements of the system may be implemented using a single processing unit, or using a plurality of processing units e.g. the control unit and the interface may be implemented using a single processing unit or using a plurality of processing units.

The host computer system may include application software that programs the host computer system to perform one or more functions according to the present invention.

The host computer system may include, for example, server computers, personal computers, workstations, web servers, and/or other suitable computing devices. The host computer system may include one or more of the aforementioned computing devices, as well as storage devices such as databases, disk drives, optical drives, and the like. The storage devices may include solid state memory, such as RAM, ROM, PROM, and the like, magnetic memory, such as disc drives, tape storage, and the like, and/or optical memory, such as DVD, and storage area networks. The host computer system may be fully located within a single facility or distributed geographically, in which case a network may be used to integrate the host computer system.

The computing devices of the first party and/or the second party may connect to any networks. The network may e.g. be a wired system, a cable network (e.g. DSL, ADSL network), a power line network, a photonic or optical network, a Local Area network (e.g. Ethernet, 802.3, 802.2, 802.1, 802.4, 802.5, Token Ring), a metropolitan area network (e.g. 802-2001, 802.6, ATM), a cellular system (e.g. 2G, 3G, 4G, GSM, GPRS, EDGE, UMTS, CDMA2000, HSPA, LTE, NGN), a wireless local area network (e.g. Wifi, 802.11, HiperLAN), a wireless metropolitan area network (e.g. 802.16 WiMAX, HiperMAN), a mobile broadband wireless access network (e.g. 802.20), a wireless personal area network (e.g. Bluetooth, Infrared, 802.11, 802.15, UWB), a private network, a virtual network, a cooperative communication network, a relay network, a grid computing network or any combination thereof.

In a third aspect, an Integrated circuit (IC) for causing an apparatus to perform a method in accordance with the first aspect is provided.

In a fourth aspect, a computer program product embodied in a computer-readable medium for causing an apparatus to perform a method in accordance with the first aspect is provided. This aspect is particularly, but not exclusively, advantageous in that the present invention may be accomplished by a computer program product enabling a computer system to carry out the operations of the apparatus/system of the first aspect of the invention when down- or uploaded into the computer system. Such a computer program product may be provided on any kind of computer readable medium, or through a network, the network being defined above. The computer readable medium may be a non-transitory computer readable medium.

The various aspect of the present invention may each be combined with any of the other aspects. These and other aspects of the invention will be apparent from and elucidated with reference to the embodiments described hereinafter.

The computing devices of the first party and/or the second party may be any computing devices, such as personal computers, labtops, tablet computers, smartphones, etc.

A transaction between two parties may be performed according to transaction information comprising at least the transaction amount in a given currency, or settlement unit and a date. The transaction amount may be agreed by both parties in a given currency, the agreed currency being selected amongst the currencies in which the parties operate, and an intermediate currency different from the ones in which the parties operate. In one or more embodiments, the first currency, the second currency, or the intermediate currency may be an aggregated currency, such as a settlement unit. A fluctuation of the exchange rate of the aggregated currency between the first date and the second date may be characterized by a difference, a deviation, or a metric reflecting a distribution of the exchange rate over a time period including at least the first date and the second date or any combination thereof.

It is envisaged that throughout the description the term settlement unit or unit for settlement may comprise a currency, an intermediate currency or an aggregated currency, and likewise, the term currency may comprise a first, second or intermediate currency and/or an aggregated currency.

The transaction information may furthermore comprise an identifier of the first party, and an identifier of the second party. However, if the parties want to remain anonymous, the identifiers may not be present in the transaction information.

The method may further comprise the step of, at the host computer system, receiving, from at least one provider, at least one agreed settlement unit exchange rate at the first date and computing, on the host computer system, a settlement amount in the agreed settlement unit based on a plurality of transaction parameters. The plurality of transaction parameters may comprise the transaction amount in the agreed settlement unit at the first date, the exchange rate between the agreed settlement unit and the first and/or second currency at the first date, a fluctuation of the exchange rate between the agreed settlement unit and the first and/or second currency between the first date and a second date, a difference in the transaction amount between the first date and the second date resulting from the fluctuation of the exchange rate between the first date and the second date, etc. The method further comprises apportioning a first share of the difference to the first party and a second share of the difference to the second party, the apportioning being performed in accordance with a predetermined apportionment method.

The method may further comprise the step of generating a report via the host computer system. The report may comprise at least some of the plurality of transaction parameters, the pre-determined apportionment method, the settlement amount, the first share of the difference and the second share of the difference, etc. The report may furthermore comprise a first settlement amount in the first currency, the first settlement amount including the settlement amount and the first share of the difference, and/or a second settlement amount in the second currency, the second settlement amount including the settlement amount and the second share of the difference. The report generated may be an electronic file.

The report generated may be received by the second party and/or by the first party, possibly together with the settlement. The first party and/or the second party may be able to determine whether the generated report is consistent with terms agreed.

Trust between the parties involved and towards the system may be considered in various ways. In one or more embodiments, the system may provide any of the parties with the ability to verify the integrity and the authenticity of the report. To this end, the report generated may be certified and/or signed, possibly digitally signed, by the provider of the system facilitating a transaction between the first party and the second party. In one or more embodiments, the provider of the system may be a trusted provider. The provider of the system may be trusted in general, or in particular by one or both of the parties, or by a group of entities. The system may also comprise a trusted third party with or without a certificate authority allowing the first party, the second party, and any other party to authenticate the report generated. The report generator of this system may further be adapted to use cryptographic functions to protect the integrity of the report generated.

In a preferred embodiment of the present invention, if the agreed currency, or the agreed settlement unit, in a direct transaction is the second currency, computing via the host computer system a settlement amount in the second currency based on a plurality of parameters may comprise:

a. converting the transaction amount in the second currency into the transaction amount in the first currency using the exchange rate at the first date;

b. receiving at the host computer system, from at least one provider at least one exchange rate between the first currency and the second currency at the second date;

c. converting the transaction amount in the second currency at the second date into the transaction amount in the first currency at the second date using the corresponding exchange rate at the second date;

d. determining a difference between the transaction amount in the first currency at the first date and the transaction amount in the first currency at the second date;

e. applying an apportionment method to the difference resulting in a share of the difference allocated to the first party and a share of the difference allocated to the second party in the first currency;

f. converting the share of the difference allocated to the second party in the first currency into the share of the difference allocated to the second party in the second currency using the received exchange rate at the second date;

g. subtracting the share of the difference allocated to the second party in the second currency at the second date from the transaction amount in the second currency at the second date resulting in a settlement amount in the second currency to be paid by the second party at the second date.

In one or more embodiments, the apportionment method may comprise determining, based on a predetermined first ratio corresponding to the share of the difference allocated to the first party, and a predetermined second ratio corresponding to the share of the difference allocated to the second party, the share of the difference allocated to the first party by applying the predetermined first ratio to the difference of the transaction amount in the first currency; and the share of the difference allocated to the second party by applying the predetermined second ratio to the difference of the transaction amount in the first currency. Ratios corresponding to the shares always add up to 1. Furthermore, once the first share allocated to the first party is determined, the second share allocated to the second party can be derived from the first share. The apportionment method may be determined or agreed, in advance or not, by the first party and/or by the second party and/or by another third party.

For example, if the parties agree to an apportionment method that equally shares the risk of the fluctuation of the exchange rate between both parties, the ratio representing the share of the difference allocated to the first party is 50% or ½, and the ratio representing the share of the difference allocated to the second party is 50% or ½. If the difference of the transaction amount in the first currency is 100 EUR, then the share of the difference allocated to the first party by applying the ratio of the first party to the difference of the transaction amount in the first currency is 100×½=50 EUR and the share of the difference allocated to the second party by applying the ratio of the second party to the difference of the transaction amount corresponding to a value of the share in the first currency is 100×½=50 EUR.

An exchange rate based on any paradigm (market determined, fixed, or fixed with a trading band) changes whenever the values of either of the two component currencies change. This is known as the fluctuation of the exchange rates. Between the date of the agreement and the date of the settlement, the fluctuation of exchange rates may have impacted the transaction amount to be transfered to the first party. This results in a difference between the transaction amount in the first currency at the date of the agreement and the settlement amount in the first currency at the date of the settlement. The fluctuation of the exchange rates in a direct transaction exposes one of the parties to a volatility risk, i.e. the threat that an exchange rate movement poses to a portfolio in a foreign currency. It is an advantage of the present invention that it may allow both parties to share the risk of the fluctuation in that an apportionment of the difference in the transaction amounts from the date of the agreement to the date of the settlement is provided.

The fluctuation of the exchange rate between the agreed currency and the first and/or second currency between the first date and the second date may be characterized by a difference, a deviation, or a metric reflecting a distribution of the exchange rate over a time period including at least the first date and the second date or any combination thereof.

In one or more embodiments, the method may further comprise monitoring, such as with the host computer system, the fluctuation of the exchange rate between the first date and a second date.

In some embodiments the method may further comprise storing, such as on a storage medium, the exchange rates over a time period, the time period including at least the first date and the second date. The exchange rates received over a time period may result in a discrete distribution of the exchange rate over the time period. A plurality of exchange rates may be received from one or more providers, and processed to output one exchange rate at a given date to be used for the determination of the settlement amount.

Processing of the plurality of exchange rates received may comprise selecting an exchange rate received from a given provider over the plurality of received exchange rates based on a metric indicative of quality of the received exchange rate, the metric being based on a trustworthiness of the provider, a reliability of the provider, a dependability of the provider, an error rate of the received exchange rates over a time period, a priority order or any combination thereof. The received exchange rates may be validated by the provider or the exchange rates may be validated upon receipt of the exchange rates.

In one or more embodiments, the method may further comprise determining whether the at least one exchange rate received at the first date is valid. Determining whether the at least one exchange rate is valid may comprise determining a deviation between the plurality of the received exchange rates; and discarding the received exchange rate if the deviation of one of the received exchange rates is above a threshold.

The system may comprise an interface for interfacing between a user of the system, such as the first and/or second party, and the host computer system. The interface may be a computing device and/or the interface may be implemented using a computer program application, such as a software program or an app. The interface may be configured to output a settlement amount at the second date, the settlement amount may be provided in the first currency, the second currency, the intermediate currency or the intermediate settlement unit. It is envisaged that the parties may operate in an intermediate settlement unit.

The system may further comprise a control unit adapted to monitor a fluctuation of the stored exchange rate between the first date and a second date and to convert an amount from the first or second or intermediate currency or settlement unit to the second or first or intermediate currency or settlement unit.

In a further embodiment of the present invention, the host computer system may be connected to a financial institution system allowing transfer of the computed settlement amount including any share of the difference from one party to another party, i.e. for example from the second party to the first party or vice versa.

### BRIEF DESCRIPTION OF THE DRAWINGS

The present invention will now be explained, by way of example only, with reference to the accompanying Figures, where:

FIG. 1 is a schematic view of a preferred architecture supporting the present invention,

FIG. 2 is a flow-chart of a preferred implementation of the invention,

FIG. 3 is a flow-chart of an exemplary implementation of the invention for a direct transaction,

FIG. 4 is a flow-chart of an exemplary implementation of the invention where an intermediate currency is used, and

FIG. 5 is a table of another exemplary implementation of the invention where an intermediate currency is used.

FIG. 6 is a table of another exemplary implementation of the invention where an intermediate currency is used and where a proportional share of the difference is allocated to each party.

### DETAILED DESCRIPTION

The description of the invention will now be made in detail to an implementation of the present invention as illustrated in the accompanying drawings and figures. Whenever possible the same reference number will be used throughout the figures and the following description to refer to the same parts. Numerous variations or modifications from the described embodiments may be possible.

The present invention may be implemented by a provider certifying transactions, a financial institution, a bank, a central bank, a clearing house, a broker, a trust company, a credit union, a corporation, or a person. The system and procedures to implement this invention provide an enhancement of cross-currency transactions at least due to a technique that allows sharing exchange rate risk between business partners.

The embodiments shown here are only examples of the invention.

As used herein the term “currency” refers to a medium of exchange used to facilitate transactions. Currency could be a monetary unit such as British pounds, U.S. dollars, and European euros. The first currency and the second currency according to the present invention are different currencies.

As used herein the term “exchange rate” between two currencies (also known as a foreign-exchange rate, forex rate, FX rate, a currency pair, etc.) refers to the rate at which one currency will be exchanged for another, currency exchange rates refers to exchanges rates of a currency between one or more other currencies. Exchange rates are provided in communication with one or more providers of exchange rates. Providers of exchange rates collect and distribute exchange rates to e.g. financial institutions or any requester. The financial institutions are identified as banks, but may more generally be any type of financial institution. Providers of exchange rates may also be financial institutions.

As used herein the term “transaction” refers to the act of conducting or carrying out an agreement or a business agreement, such as an exchange or a trade. A transaction takes place between two, or more parties.

As used herein the term “party” refers to an entity which is e.g an individual, a group of individuals, a community, a company, an organization, a department, a state, a machine, an object with a communication capability or in association with a communication device, or any combination thereof. As used herein the terms “first party” with respect to “second party” refers to the parties of the transaction, such as a seller of an asset with respect to a buyer, a sender of a good, a service or a right with respect to a receiver of the same.

As used herein the terms “first date” with respect to “second date” refers to the date of the agreement or transaction between the first party and the second party with respect to the date of the settlement i.e. when the settlement amount is settled or received by one of the parties and the transaction thus may be completed.

As used herein the term “apportionment” of the difference between the first party and the second party refers to a division or a distribution of the difference between the first party and the second party. The apportionment of the difference may be agreed between both parties possibly prior to settlement. The apportionment method may be part of the terms of an agreement between both parties. The apportionment of the difference results in a share of the difference allocated to the first party and a share of the difference allocated to the second party. This way, the risk is distributed/shared between both parties in accordance with the pre-agreed apportionment.

The apportionment method may comprise:

a. a ratio corresponding to the share of the difference allocated to the first party, and a ratio corresponding to the share of the difference allocated to the second party;

b. determining the share of the difference allocated to the first party by applying the ratio of the first party to the difference of the transaction amount in the first currency;

c. determining the share of the difference allocated to the second party by applying the ratio of the second party to the difference of the transaction amount in the first currency.

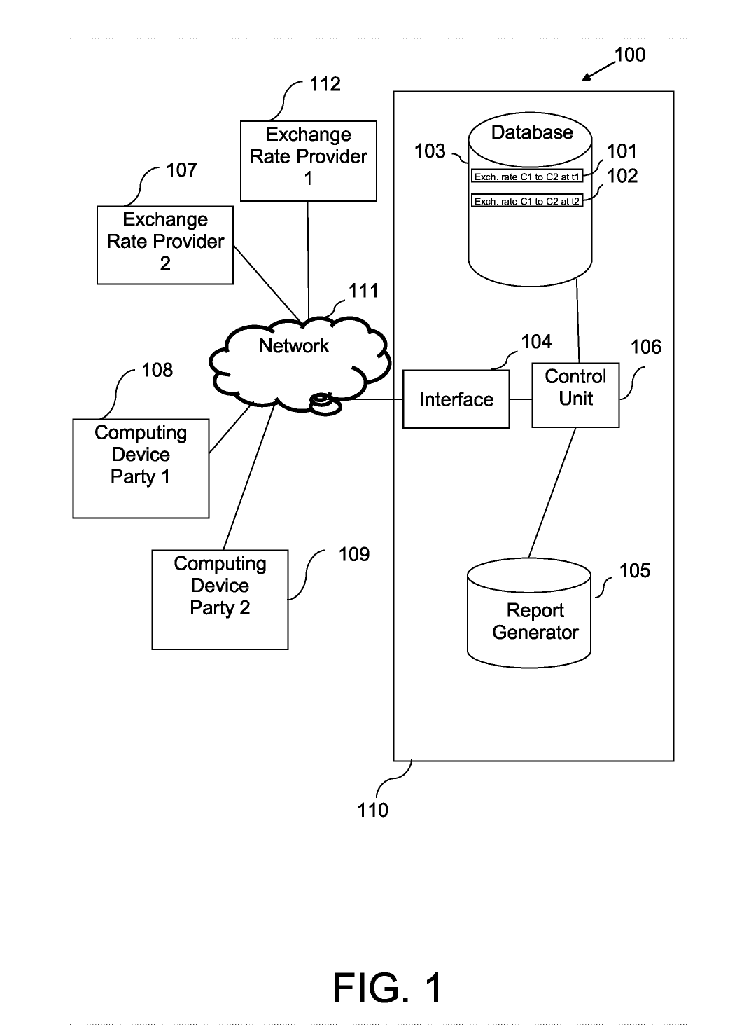

FIG. 1 shows the architecture 100 illustrating elements comprised in the systems for facilitating a transaction between a first party controlling a computing device 108 and a second party controlling a computing device 109: the host computer system 110 comprising an interface 104, a control unit 106, a database 103 storing exchange rates 101 and 102, and a report generator 105, communicating via a network 111 with two exchange rate providers 107 and 112.

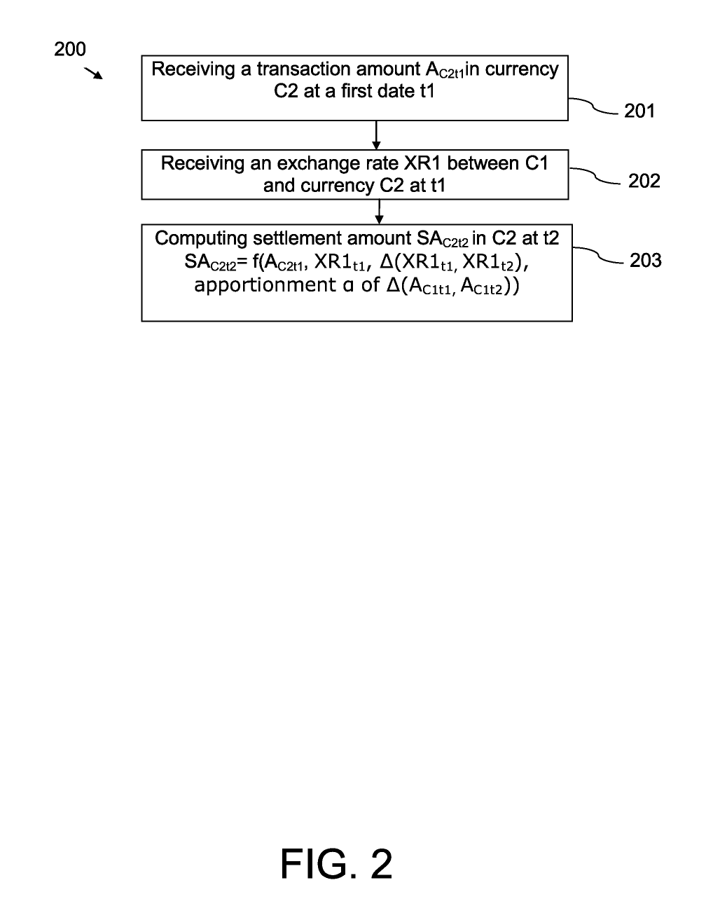

FIG. 2 shows a flowchart illustrating an exemplary implementation 200 of a direct transaction in the present invention. In this exemplary implementation, the agreed settlement unit of the direct transaction is the second currency. Without loss of generality, the present invention can be carried out in the same way with the reverse selection of currency, i.e. the agreed settlement unit is the first currency.

In FIG. 2, at step 201, the host computer system 110 receives from the computing device 108 of the first party transaction information, the transaction information comprising at least a transaction amount A1_{C2t1} in the second currency C2 and a first date t1. At step 202, the host computer system 110 receives, from at least one of the exchange rate providers 107 and/or 112, at least one exchange rate XR1 between C1 and currency C2 at t1. At step 203, the host computer system 110 computes a settlement amount in the second currency C2 SA_{C2t2} based on a plurality of parameters, the parameters comprising:
the transaction amount A_{C2t1} in the second currency C2 at the first date t1,
the exchange rate XR1ₜ₁ between the first currency and the second currency at the first date t1,
a fluctuation Δ(XR1ₜ₁, XR1ₜ₂) of the exchange rate between the first currency and the second currency between the first date and a second date, resulting in difference in the transaction amount at the second date: ∂(A_{C1t1}, A_{C1t2})
an apportionment method a; the apportionment method α being pre-determined by the first party and/or the second party to allocate to each party a share of the difference in the transaction amount at the second date resulting from the fluctuation of the exchange rate.

In one or more embodiments, the host computer system 110 receives the transaction amount A_{C2t1} via the interface 104, and stores the exchange rates XR1ₜ₁ 101 and XR1ₜ₂102 in the database 103. Then the control unit 106 of the host computer system computes the settlement amount SA_{C2t2} based on its computations of the fluctuation Δ(XR1ₜ₁, XR1ₜ₂) between XR1ₜ₁ 101 and XR1ₜ₂102, the resulting difference ∂(A_{C1t1}, A_{C1t2}) in the transaction amount at the second date, the share of the difference allocated to each party based on the apportionment method α. The interface 104 may further be adapted to output the settlement amount SA_{C2t2} in the second currency at the second date.

In one or more embodiments, the host computer system 110 uses a report generator 105 to generate a report, the report comprising the transaction information, the pre-determined apportionment method α, the settlement amount SA_{C2t2} to be paid by the second party in the second currency at the second date, and the corresponding settlement amount SA_{C1t2} to be received by the first party in the first currency at the second date.

The report generated may be received by the second party and/or by the first party. The first party and/or the second party may be able to determine whether the generated report is consistent with terms agreed.

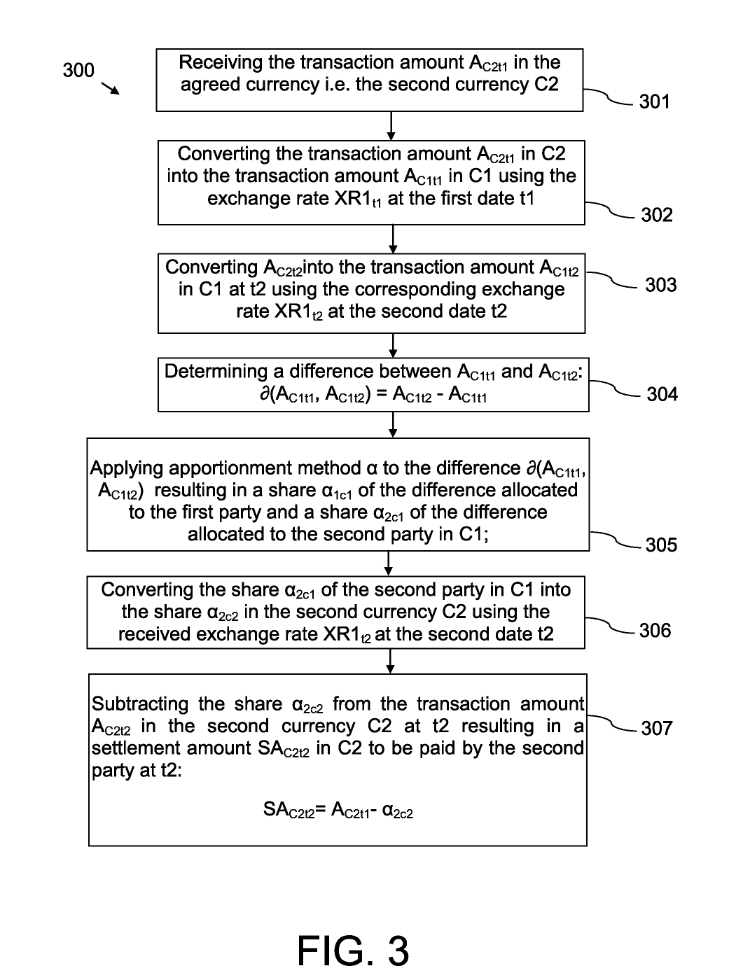

FIG. 3 shows a flowchart illustrating an exemplary implementation 300 of the computation step 203 of FIG. 2. The control unit 106 performs the following steps as shown in FIG. 3:
Step 301: Receiving the transaction amount A_{C2t1} in the agreed currency i.e. the second currency C2;
Step 302: Converting the transaction amount A_{C2t1} in the second currency C2 into the corresponding transaction amount in the first currency C1 using the exchange rate XR1ₜ₁ at the first date t1;
Step 303: Converting the transaction amount A_{C2t2} in the second currency C2 at the second date t2 into the corresponding transaction amount A_{C1t2} in the first currency C1 at the second date t2 using the corresponding exchange rate XR1ₜ₂ at the second date t2; the exchange rate XR1ₜ₂ being received by the host computer system;
Step 304: Determining a difference between the transaction amount A_{C1t1} in the first currency C1 at the first date t1 and the transaction amount A_{C1t2} in the first currency C1 at the second date t2: ∂(A_{C1t1}, A_{C1t2})=A_{C1t2}−A_{C1t1}
Step 305: Applying an apportionment method α to the difference ∂(A_{C1t1}, A_{C1t2}) resulting in a share α_{1c1} of the difference allocated to the first party and a share α_{2c1} of the difference allocated to the second party in the first currency;
Step 306: Converting the share α_{2c1} of the difference allocated to the second party in the first currency C1 into the share α_{2c2} of the difference allocated to the second party in the second currency C2 using the received exchange rate XR1ₜ₂ at the second date t2;
Step 307: Subtracting the share α_{2c2} of the difference allocated to the second party in the second currency C2 at the second date t2 from the transaction amount A_{C2t2} in the second currency C2 at the second date t2 resulting in a settlement amount SA_{C2t2} in the second currency C2 to be paid by the second party at the second date t2: SA_{C2t2}=A_{C2t1}−α_{2c2}

For example, a trade between a seller (first party) operating in Swedish Kroner SEK (first currency C1) and a buyer (second party) operating in Euros EUR (second currency C2) is performed. The seller and the buyer agree to denominate the transaction in EUR. The buyer and the seller agree at the time of the agreement t1 that the transaction amount A_{C2t1} is 100 000 EUR. For the seller, the transaction amount at the time of the agreement t1 converted with the exchange rate XR1ₜ₁ of 1 EUR to 8.5 SEK corresponds to A_{C1t1} 850 000 SEK. Table 1 illustrates an example of the mitigation of the currency risk by sharing or spliting when the EUR raises with respect to the SEK between the time of the agreement and the time of the settlement, i.e. that 1 EUR at the time of the settlement is traded for an amount of SEK, namely 8.8 SEK, which is a higher amount than 8.5 SEK at the time of the agreement. Table 1 shows an example of the computation of the settlement amount SA_{C2t2} in the second currency EUR to be paid by the buyer at the time of settlement t2 where the apportionment method agreed by both parties is to each share 50% of the difference resulting from the exchange rate fluctuation.

TABLE 1
Example of the computation of the settlement amount with the apportionment method
of 50% of the difference allocated to each party.

| | | | Second party: Buyer |
|---|---|---|---|
| | First party: Seller | | (Currency for denomination |
| | (C1: SEK) | Exchange Rate | and settlement C2: EUR) |
| Transaction Amount | A_{C1t1} = 850,000 | 8.5 SEK = | A_{C2t1} = 100,000 |
| at t1 time of the | | 1 EUR | |
| agreement | | | |
| Before mitigation: | A_{C1t2} = 880,000 | 1 EUR = | A_{C2t2} = 100,000 |
| Transaction Amount | | 8.8 SEK | |
| at t2 time of the | | | |
| settlement | | | |
| Difference | $\begin{matrix}\partial ( {A}_{C 1 t 1} , {A}_{C 1 t 2} ) = {A}_{C 1 t 2} - {A}_{C 1 t 1} \\ = 30 , 000\end{matrix}$ | | |
| Mitigation: Share of the difference | $\begin{matrix}{α}_{1 c 1} = \partial ( {A}_{C 1 t 1} , {A}_{C 1 t 2} ) \times 50 \% \\ = 30 , 000 \times 50 \% \\ = 15 , 000\end{matrix}$ | | $\begin{matrix}{α}_{2 c 2} = \partial ( {A}_{C 1 t 1 ,} {A}_{C 1 t 2} ) \times 50 \% \times XR {1}_{t 2} \\ = 15 , 000 SEK \times XR {1}_{t 2} \\ = 1 , 705\end{matrix}$ |
| Settlement Amount SA at t2 time of the settlement | $\begin{matrix}Corresp . {SA}_{C 1 t 2} = {SA}_{C 2 t 2} \times XR {1}_{t 2} \\ = {A}_{C 1 t 2} - {α}_{1 c 1} \\ = 865 , 000\end{matrix}$ | | $\begin{matrix}{SA}_{C 2 t 2} = {A}_{C 2 t 2} - {α}_{2 c 2} \\ = 100 , 000 - 1 , 705 \\ = 98 , 295\end{matrix}$ |

Table 2 illustrates the sharing or split of the risk when the EUR drops with respect to the SEK between the time of the agreement and the time of the settlement, i.e. that 1 EUR at the time of the settlement is traded for an amount of SEK, namely 8.3 SEK, lower than at the time of the agreement 8.5 SEK. Table 2 shows an example of the computation of the settlement amount SA_{C2t2} in the second currency EUR to be paid by the buyer at the date of settlement t2 where the apportionment method agreed by both parties to share the difference resulting from the exchange rate fluctuation is 25% share allocated to the buyer and 75% share allocated to the seller.

TABLE 2
Example of the computation of the settlement amount with the apportionment method
of 25% share allocated to the buyer and 75% share allocated to the seller

| | | | Second party: Buyer |
|---|---|---|---|
| | | | (Currency for |
| | First party: Seller | | denomination and |
| | (C1: SEK) | Exchange Rate | settlement C2: EUR) |
| Transaction Amount | A_{C1t1} = 850,000 | 8.5 SEK = | A_{C2t1} = 100,000 |
| at t1 time of the | | 1 EUR | |
| agreement | | | |
| Before mitigation: | A_{C1t2} = 830,000 | 1 EUR = | A_{C2t2} = 100,000 |
| Transaction Amount | | 8.3SEK | |
| at t2 time of the | | | |
| settlement | | | |
| Difference | $\begin{matrix}\partial ( {A}_{C 1 t 1} , {A}_{C 1 t 2} ) = {A}_{C 1 t 2} - {A}_{C 1 t 1} \\ = - 20 , 000\end{matrix}$ | | |
| Mitigation: Share of the difference | $\begin{matrix}{α}_{1 c 1} = \partial ( {A}_{C 1 t 1} , {A}_{C 1 t 2} ) \times 75 \% \\ = - 20 , 000 \times 75 \% \\ = - 15 , 000\end{matrix}$ | | $\begin{matrix}{α}_{2 c 2} = \partial ( {A}_{C 1 t 1 ,} {A}_{C 1 t 2} ) \times XR {1}_{t 2} \times 25 \% \\ = - 5 , 000 SEK \times XR {1}_{t 2} \\ = - 602\end{matrix}$ |
| Settlement Amount SA at t2 time of the settlement | $\begin{matrix}Corresp . {SA}_{C 1 t 2} = {SA}_{C 2 t 2} \times XR {1}_{t 2} \\ = 835 , 000\end{matrix}$ | | $\begin{matrix}{SA}_{C 2 t 2} = {A}_{C 2 t 2} - {α}_{2 c 2} \\ = 100 , 000 - ( - 602 ) \\ = 100 , 602\end{matrix}$ |

The fluctuation of the exchange rate between the first currency and the second currency between the first date and the second date may be characterized by a difference, a deviation, or a metric reflecting a distribution of the exchange rate over a time period including at least the first date and the second date or any combination thereof. The exchange rates received over a time period may result in a discrete distribution of the exchange rate over the time period.

In one or more embodiments, the host computer system 110 monitors the fluctuation of the exchange rate between the first date and the second date, and stores, on a storage medium such as the database 103, the exchange rates for a time period, the time period including at least the first date and the second date.

In one or more embodiments, the host computer system 110 receives a plurality of exchange rates between the first currency and the second currency from one or more providers at a given time. For example the control unit 106 processes the plurality of exchange rates to output one exchange rate at a given time to be used according to the invention, for example in the implementation illustrated in FIG. 2.

The host computer system 110 may determine, possibly using the control unit 106, whether the at least one exchange rate received at the first date is valid. Determining whether the at least one exchange rate is valid may comprise determining a deviation between the plurality of the received exchange rates; and discarding the received exchange rate if the deviation of one of the received exchange rates is above a threshold.

The received exchange rates may also be validated by the provider.

In one or more embodiments, the transaction between the first party and the second party may be performed using an intermediate currency for denomination and settlement, the intermediate currency being different from the first currency and the second currency and agreed between the first party and the second party.

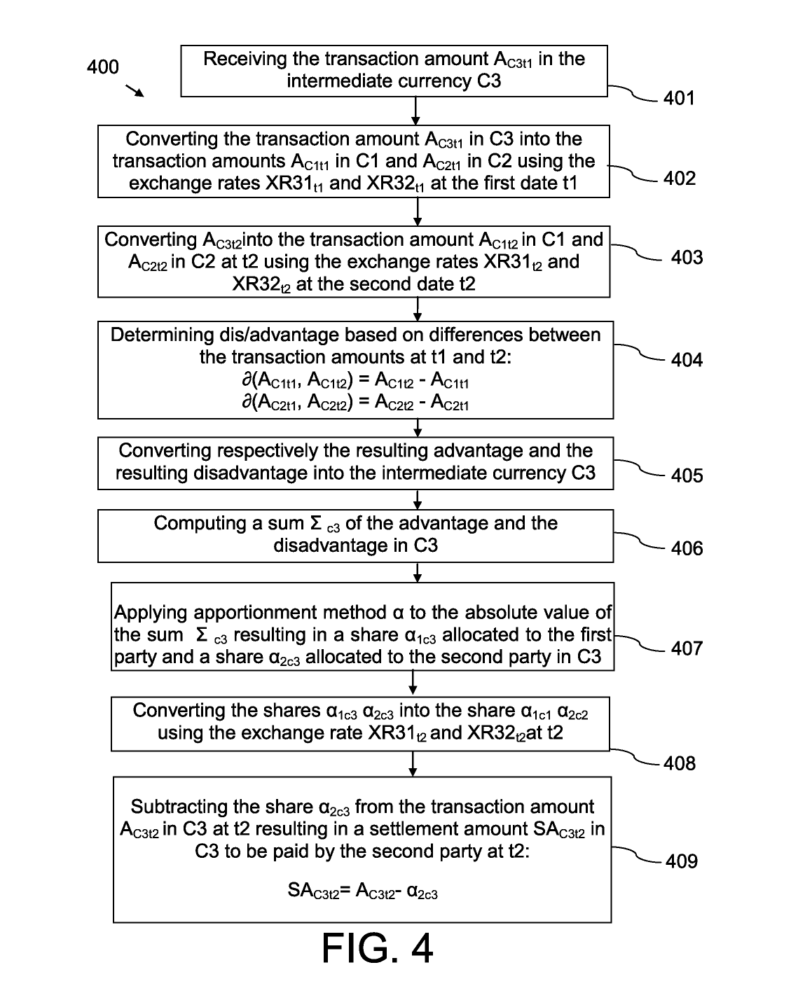

FIG. 4 shows a flowchart illustrating an exemplary implementation 400 of the computation step 203 of FIG. 2 where the agreed currency for denomination and settlement is an intermediate currency C3. The first party here is a seller and the second party is the buyer. The control unit 106 performs the following steps as shown in FIG. 4:
Step 401: Receiving the transaction amount A_{C3t1} in the agreed currency i.e. the intermediate currency C3;
Step 402: Converting the transaction amount A_{C3t1} in the agreed intermediate currency C3 into the corresponding transaction amount A_{C1t1} in the first currency C1 using the exchange rate XR31ₜ₁ at the first date t1 and into the corresponding transaction amount A_{C2t1} in the second currency C2 using the exchange rate XR32ₜ₁ at the first date t1;
Step 403: Converting the transaction amount A_{C3t2} in the intermediate currency C3 at the second date t2 into the corresponding transaction amount A_{C1t2} in the first currency C1 at the second date t2 using the corresponding exchange rate XR31ₜ₂ at the second date t2 and the corresponding transaction amount A_{C2t2} in the second currency C2 at the second date t2 using the corresponding exchange rate XR32ₜ₂ at the second date t2;
Step 404: Determining a difference between the transaction amounts at the first date t1 and the transaction amounts at the second date t2:

∂(A_{C1t1},A_{C1t2})=A_{C1t2}−A_{C1t1}

∂(A_{C2t1},A_{C2t2})=A_{C2t2}−A_{C2t1}

The determined difference ∂(A_{C1t1}, A_{C1t2}) is considered as an advantage for the first party (being the seller) if the determined difference ∂(A_{C1t1}, A_{C1t2}) is positive; otherwise, the determined difference ∂(A_{C1t1}, A_{C1t2}) is a disadvantage for the first party; the advantage bearing a positive sign and the disadvantage bearing a negative sign. A function f^{seller} is defined here to apply, or not to apply, an additive inverse to the determined difference based on whether it is an advantage or a disadvantage for the first party as a seller:

f^{seller}(DisAdv,Adv)=(−1×∂,∂)

For the second party, if the additive inverse value of the determined difference θ(A_{C2t1}, A_{C2t2}) is positive, the additive inverse value of the determined difference ∂(A_{C2t1}, A_{C2t2}) is considered as an advantage for the second party; otherwise, the determined difference ∂(A_{C1t1}, A_{C1t2}) is a disadvantage for the second party. A function f^{buyer} is defined here to apply, or not to apply, an additive inverse to the determined difference based on whether it is an advantage or a disadvantage for the second party as a buyer:

f^{Buyer}(DisAdv,Adv)=(−1×∂,∂)
Step 405: Converting respectively the resulting advantage and the resulting disadvantage into the intermediate currency C3;
Step 406: Computing a sum Σ_{c3} of the advantage and the disadvantage respectively converted in the intermediate currency C3;
Step 407: Applying an apportionment method α to the absolute value of the sum Σ_{c3} resulting in a share α_{1c3} of the sum allocated to the first party and a share α_{2c3} of the difference allocated to the second party in the intermediate currency C3;
Step 408: Converting the share α_{1c3} allocated to the first party in the intermediate currency C3 into share α_{1c1} allocated to the first party in the first currency C1 using the received exchange rates XR31ₜ₂ at the second date t2; Converting the share α_{2c3} allocated to the second party in the intermediate currency C3 into share α_{2c2} allocated to the second party in the second currency C2 using the received exchange rates XR32ₜ₂ at the second date t2;
Step 409: Subtracting the share α_{2c3} allocated to the second party in the intermediate currency C3 at the second date t2 from the transaction amount A_{C3t2} in the intermediate currency C3 at the second date t2 resulting in a settlement amount SA_{C3t2} in the intermediate currency C3 to be paid by the second party at the second date t2:

SA_{C3t2}=A_{C3t2}−α_{2c3}

Note that SA_{C3t2} is also equal to SA_{C2t2}×XR23ₜ₂.

For example, the first party, e.g. seller, operating in Norwegian kroners NOK and the second party e.g. buyer operating in GBP may agree to a transaction amount at the first date t1 of the agreement in an intermediate currency EUR. Let us assume a transaction amount A_{C3t1} denominated in EUR as 100 000 EUR. For the seller, this corresponds to a transaction amount A_{C1t1} of 735 000 NOK while for the buyer, this corresponds to a transaction amount A_{C2t1} of 80 300 GBP. At a later date t2 of settlement, the exchange rates between EUR and NOK as well as between EUR and GBP have changed. Thus, at t2, for the seller, 100 000 EUR corresponds to a transaction amount A_{C1t2} of 749 000 NOK while for the buyer, 100 000 EUR corresponds to a transaction amount A_{C2t2} of 86 600 GBP.

Table 3 illustrates the sharing or split of the risk when the EUR raises with respect to the NOK and GBP between the time of the agreement and the time of the settlement. Table 3 shows an example of the computation of the settlement amount SA_{C3t2} at the date of settlement t2 where the apportionment method agreed by both parties to share the difference resulting from the exchange rate fluctuation is 50% share allocated to the buyer and 50% share allocated to the seller.

TABLE 3
Example of the computation of the settlement amount with the apportionment method
of 50% of the difference allocated to each party and using an intermediate currency

| | | Intermediate currency | |
|---|---|---|---|
| | First party: Seller | (Currency for denomination | Second party:Buyer |
| | (C1: NOK) | and settlement C3: EUR) | (C2: GBP) |
| Transaction | A_{C1t1} = 735,000 | A_{C3t1} = 100,000 | A_{C2t1} = 80,300 |
| Amount | | | |
| at t1 time of the | | | |
| agreement | | | |
| Before | A_{C1t2} = 749,000 | A_{C3t2} = 100,000 | A_{C2t2} = 86,600 |
| mitigation: | | | |
| Transaction | | | |
| Amount | | | |
| at t2 time of the | | | |
| settlement | | | |
| Difference | $\begin{matrix}\partial ( {A}_{C 1 t 1} , {A}_{C 1 t 2} ) = {A}_{C 1 t 2} - {A}_{C 1 t 1} \\ = 14 , 000\end{matrix}$ | | $\begin{matrix}\partial ( {A}_{C 2 t 1} , {A}_{C 2 t 2} ) = {A}_{C 2 t 2} - {A}_{C 2 t 1} \\ = 6 , 300\end{matrix}$ |
| Advantage Adv/ Disadvantage Disadv | $\begin{matrix}{Adv}_{C 1} = + \partial ( {A}_{C 1 t 1} , {A}_{C 1 t 2} ) \\ = + 14 , 000\end{matrix}$ | $\begin{matrix}\begin{matrix}{Adv}_{c 3} = {Adv}_{C 1} \times XR {13}_{t 2} \\ = 1 , 869\end{matrix} \\ \begin{matrix}{Disadv}_{c 3} = {Disadv}_{C 2} \times XR {23}_{t 2} \\ = - 7 , 275\end{matrix} \\ \begin{matrix}{Σ}_{c 3} = {Adv}_{c 3} + {Disadv}_{c 3} \\ = 1 , 869 + ( - 7 , 275 ) \\ = - 5 , 406\end{matrix} \\ \begin{matrix}{α}_{1 c 3} = \vert Σ c 3 \vert \times 50 \% \\ = 2 , 703\end{matrix} \\ \begin{matrix}{α}_{2 c 3} = \vert Σ c 3 \vert \times 50 \% \\ = 2 , 703\end{matrix}\end{matrix}$ | $\begin{matrix}{Disadv}_{C 2} = - \partial ( {A}_{C 2 t 1} , {A}_{C 2 t 2} ) \\ = - 6 , 300\end{matrix}$ |
| Mitigation: Share of the difference | $\begin{matrix}{α}_{1 c 1} = {α}_{1 c 3} \times XR {31}_{t2} \\ = 2 , 703 \times XR {31}_{t2} \\ = 20 , 245\end{matrix}$ | | $\begin{matrix}{α}_{2 c 2} = {α}_{2 c 3} \times XR {32}_{t 2} \\ = 2 , 703 \times XR {32}_{t 2} \\ = 2 , 341\end{matrix}$ |
| Settlement Amount at t2 time of the settlement | $\begin{matrix}Corresp . {SA}_{C 1 t 2} = {SA}_{C 3 t 2} \times XR {31}_{t 2} \\ = {A}_{C 1 t 2} - {α}_{1 c 1} \\ = 728 , 755\end{matrix}$ | $\begin{matrix}{SA}_{C 3 t 2} = {A}_{C 3 t 2} - {α}_{2 c 3} \\ = 97 , 297\end{matrix}$ | $\begin{matrix}Corresp . {SA}_{C 2 t 2} = {A}_{C 2 t 2} - {α}_{2 c 2} \\ = 86 , 600 - 2 , 341 \\ = 84 , 259\end{matrix}$ |

The settlement amount paid by the second party at t2 in C3 EUR and received by the first party is subject to variations of the exchange rate between C3 and C1 that the first party receives at t2.

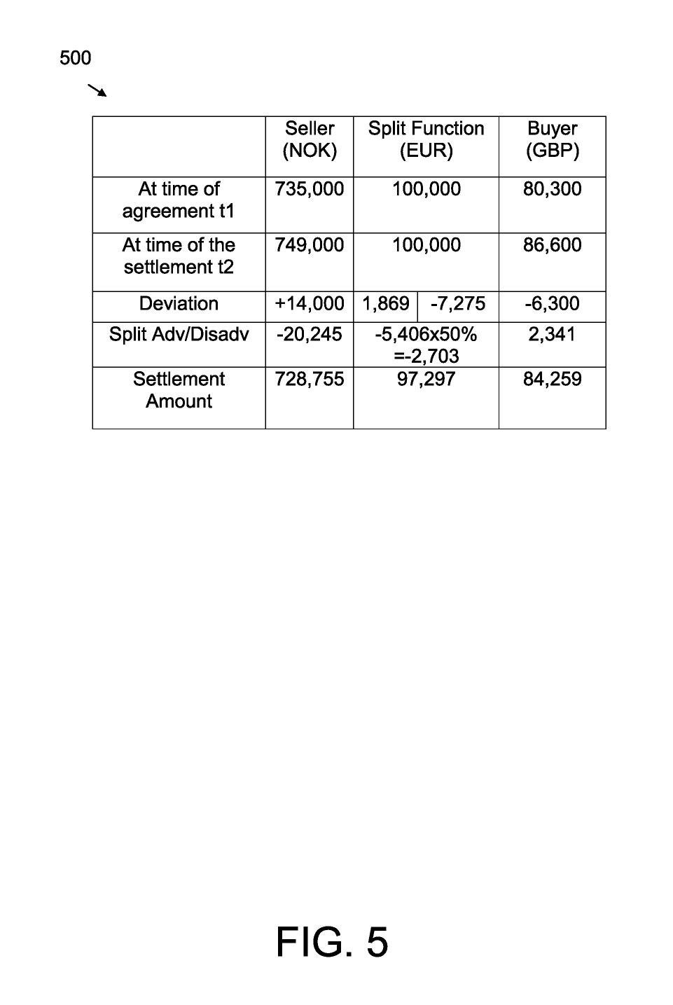

FIG. 5 illustrates another way of implementing the computation of the settlement amount with the apportionment method of 50% of the difference allocated to each party and using the following currencies: C3: EUR, C1: NOK, C2: GBP.

In FIG. 5, the term split function is to be understood as the intermediate currency selected as the agreed unit for settlement used for denomination and settlement, and the computations carried in this currency to determine the shares of each party. The term deviation corresponds to the term difference used in FIG. 4. The term split of advantage/disadvantage is related to the apportionment method.

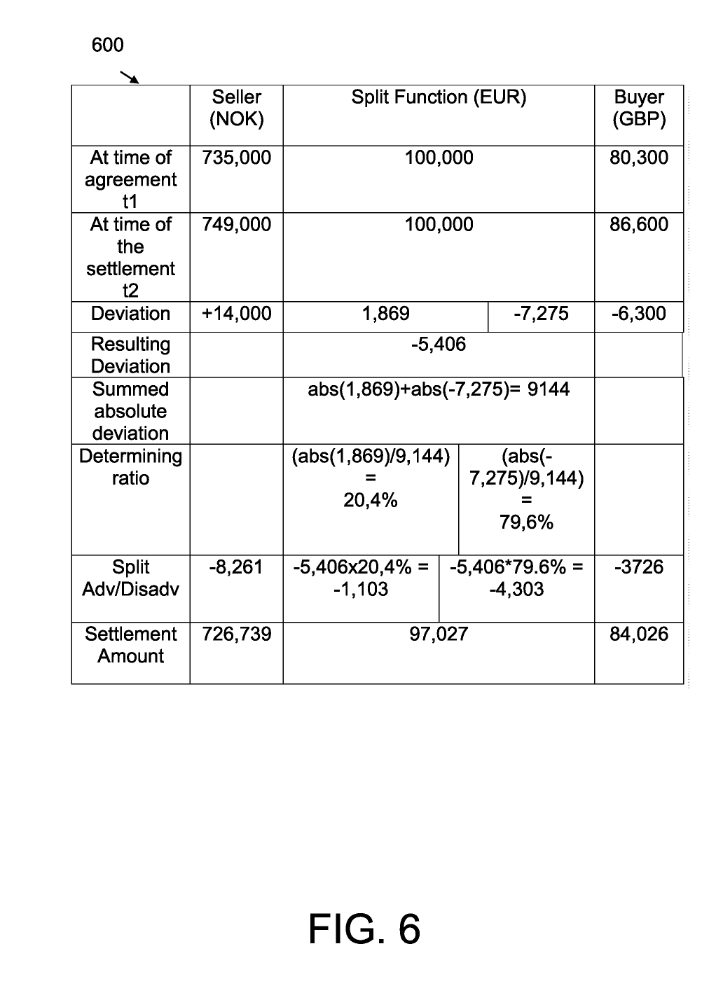

FIG. 6 illustrates a way of implementing the computation of the settlement amount, where the apportionment method determines the share of the difference allocated to each party by taking into account the proportional movement of the first currency and the second currency relative to the settlement unit. In this embodiment, the summed absolute deviation is determined and used to find a ratio of movement of the first currency and the second currency with respect to the settlement unit. This ratio is used to determine an advantage/disadvantage for each party. The advantage/disadvantage is for the seller summed with the sellers transaction amount at t1 (time of agreement) to determine the settlement amount in the first currency, and for the buyer subtracted with the buyers transaction amount at t1 to determine the settlement amount in the second currency. The settlement amount in the first and second currency will equal the same amount in the settlement unit. Thus, to determine the settlement amount in the settlement unit, the settlement amount in the first currency or the settlement in the second currency may be used (together with their respective exchange rate with respect to the settlement unit).

The first currency, the second currency or the intermediate currency may be an aggregated artificial currency. An aggregated currency is a virtual currency unit comprising a plurality of underlying currencies, each underlying currency having a respective weighting e.g. an aggregated currency unit may comprise 30% US dollar, 25% Euro, 15% Japanese Yen, 10% Swiss franc, 10% Australian dollar, and 10% Canadian dollar.

The systems and methods as herein described may be implemented in any suitable form including hardware, software, firmware or any combination of these. The systems and methodsmay be implemented as computer software running on one or more data processors and/or digital signal processors. The elements and components of any embodiments may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for facilitating a transaction between a first party and a second party, the first party operating in a first currency, the second party operating in a second currency different from the first currency, the method comprising:
receiving, at a host computer system, transaction information, the transaction information comprising at least a transaction amount in an agreed settlement unit and a first date, the agreed settlement unit being selected from a group consisting of the first currency, the second currency, an intermediate currency and an intermediate settlement unit;
receiving, at the host computer system, from at least one provider at least one agreed settlement unit exchange rate at the first date; and
computing, on the host computer system, a settlement amount in the agreed settlement unit based on:
a plurality of transaction parameters, the transaction parameters comprising the transaction information, the exchange rate between the agreed settlement unit and the first and/or second currency at the first date, a fluctuation of the exchange rate between the agreed settlement unit and the first and/or second currency between the first date and a second date, and
an apportionment method, the apportionment method being pre-determined to allocate to each party a share of a difference in the transaction amount between the first date and the second date resulting from the fluctuation of the exchange rate.

2. A method according to claim 1 further comprising:
computing, on the host computer system, a difference in the transaction amount between the first date and the second date resulting from a fluctuation of the settlement unit exchange rate between the first date and the second date; and
apportioning a first share of the difference to the first party and a second share of the difference to the second party, the apportioning being performed in accordance with a predetermined apportionment method.

3. A method according to claim 1 further comprising generating a report via the host computer system, the report comprising at least some of the plurality of transaction parameters, the pre-determined apportionment method, the settlement amount, the first share of the difference and the second share of the difference.

4. A method according to claim 3, wherein the report further comprises a settlement amount in the agreed settlement unit, and at least one corresponding settlement amount in a currency different from the agreed settlement unit including the corresponding share of the difference.

5. A method according to claim 3, wherein the report generated is an electronic file.

6. A method according to claim 3, wherein the report generated is received by the second party and/or by the first party.

7. A method according to claim 3, wherein the first party and/or the second party determines whether the generated report is consistent with terms agreed.

8. A method according to claim 3, wherein the report generated is certified by the provider of the system facilitating the transaction between a first party and a second party.

9. A method according to claim 1, wherein computing on the host computer system a settlement amount of a direct transaction in the second currency based on a plurality of transaction parameters, the method comprises:
receiving at the host computer system, from at least one provider at least one exchange rate between the first currency and the second currency at the first date;
converting the transaction amount in the second currency into the transaction amount in the first currency using the exchange rate at the first date;
receiving at the host computer system, from at least one provider at least one exchange rate between the first currency and the second currency at the second date;
converting the transaction amount in the second currency at the second date into the transaction amount in the first currency at the second date using the corresponding exchange rate at the second date;
determining a difference between the transaction amount in the first currency at the first date and the transaction amount in the first currency at the second date;
applying an apportionment method to the difference resulting in a share of the difference being allocated to the first party and a share of the difference being allocated to the second party in the first currency;
converting the share of the difference allocated to the second party in the first currency into the share of the difference allocated to the second party in the second currency using the received exchange rate at the second date; and
subtracting the share of the difference allocated to the second party in the second currency at the second date from the transaction amount in the second currency at the second date resulting in a settlement amount in the second currency to be paid by the second party at the second date.

10. A method according to claim 1, wherein the apportionment method comprises:
a ratio corresponding to the share of the difference allocated to the first party, and a ratio corresponding to the share of the difference allocated to the second party;
determining the share of the difference allocated to the first party by applying the ratio of the first party to the difference of the transaction amount in the first currency; and
determining the share of the difference allocated to the second party by applying the ratio of the second party to the difference of the transaction amount in the first currency.

11. A method according to claim 1, wherein the transaction information further comprises an identifier of the first party, and an identifier of the second party.

12. A method according to claim 1, wherein the transaction amount in the agreed settlement unit is agreed between the first party and the second party at the first date.

13. A method according to claim 1, wherein the fluctuation of the exchange rate between the agreed settlement unit and the first and/or second currency between the first date and the second date is characterized by a difference, a deviation, or a metric reflecting a distribution of the exchange rate over a time period including at least the first date and the second date or any combination thereof.

14. A method according to claim 1 further comprising monitoring, with the host computer system, the fluctuation of the exchange rate between the first date and a second date.

15. A method according to claim 1 further comprising storing, on a storage medium, the exchange rates for a time period, the time period including at least the first date and the second date.

16. A method according to claim 1, wherein the exchange rates received over a time period result in a discrete distribution of the exchange rate over the time period.

17. A method according to claim 1 further comprising receiving one or more exchange rates from one or more providers, and processing the one or more exchange rates to output at least one settlement unit exchange rate at a given date.

18. A method according to claim 17, wherein processing of a plurality of exchange rates received comprises selecting an exchange rate received from a given provider over the plurality of received exchange rates based on a metric indicative of quality of the received exchange rate, the metric being based on a trustworthiness of the provider, a reliability of the provider, a dependability of the provider, an error rate of the received exchange rates over a time period, a priority order or any combination thereof.

19. A method according to claim 1 further comprising determining whether the at least one exchange rate received at the first date is valid.

20. A method according to claim 19, wherein determining whether the at least one exchange rate is valid comprises determining a deviation between the plurality of the received exchange rates; and discarding the received exchange rate if the deviation of one of the received exchange rates is above a threshold.

21. A method according to claim 1, wherein the received exchange rates are validated by the provider.

22. A method according to claim 1, wherein the transaction between the first party and the second party is performed using an intermediate settlement unit, the intermediate settlement unit being different from the first currency and the second currency and agreed upon between the first party and the second party.

23. A method according to claim 22, wherein the difference to be apportioned is an accumulated difference, the accumulated difference being computed from the difference in the transaction amount in the first currency between the first date and the second date resulting from the fluctuation of the exchange rate between the agreed settlement unit and the first currency, and the difference in the transaction amount in the second currency between the first date and the second date resulting from the fluctuation of the exchange rate between the agreed settlement unit and the second currency.

24. A method according to claim 1, wherein the first currency, the second currency, the intermediate currency, or the intermediate settlement unit is an aggregated settlement unit.

25. A method according to claim 24, wherein a fluctuation of the exchange rate between the intermediate settlement unit and the first and/or second currency between the first date and the second date is characterized by a difference, a deviation, or a metric reflecting a distribution of the exchange rate over a time period including at least the first date and the second date or any combination thereof.

26. A system facilitating a transaction between a first party and a second party, the first party operating in a first currency, the second party operating in a second currency different from the first currency, the system comprising:
an interface configured to receive transaction information, the transaction information comprising at least a transaction amount in an agreed settlement unit and a first date, the agreed settlement unit being selected from a group consisting of the first currency, the second currency, an intermediate currency and an intermediate settlement unit;
a database configured to receive from at least one provider at least one agreed settlement unit exchange rate at the first date and to store the received exchange rate; and
a control unit adapted to compute a settlement amount in the agreed settlement unit based on
a plurality of transaction parameters, the transaction parameters comprising the transaction information, the agreed settlement unit exchange rate at the first date, a fluctuation of the exchange rate between the agreed settlement unit and the first and/or second currency between the first date and a second date, and
an apportionment method, the apportionment method being pre-determined by to allocate to each party a share of a difference in the transaction amount between the first date and the second date resulting from the fluctuation of the exchange rate.

27. A system according to claim 26 wherein the control unit is further configured to compute a settlement amount in the agreed settlement unit based on a plurality of transaction parameters, the transaction parameters comprising the transaction amount in the agreed settlement unit at the first date, the agreed settlement unit exchange rate at the first date, a fluctuation of the exchange rate between the agreed settlement unit and the first and/or second currency between the first date and a second date, a difference in the transaction amount between the first date and the second date resulting from the fluctuation of the exchange rate; wherein the control unit is further configured to apportion a first share of the difference to the first party and a second share of the difference to the second party, the apportioning being performed in accordance with a predetermined apportionment method.

28. A system according to claim 26 further comprising a report generator adapted to generate a report, the report comprising the transaction information, the pre-determined apportionment method, the settlement amount at the second date.

29. A system according to claim 26, wherein the control unit is further adapted to monitor the fluctuation of the stored settlement unit exchange rate between the first date and a second date and to convert an amount from the agreed settlement unit, the first or the second or the intermediate currency to the second or the first or the intermediate currency.

30. A system according to claim 26, wherein the interface is further adapted to output a settlement amount in the first and/or second currency at the second date.

31. A system according to claim 26 further comprising a trusted third party with or without a certificate authority allowing the first party, the second party, and any other party to authenticate the report generated.

32. A system according to claim 26, wherein a report generator is further adapted to use cryptographic functions to protect the integrity of the report generated.

33. A system according to claim 26, further comprising a connection to a financial institution system allowing the second party to transfer the settlement amount to the first party.

34. An integrated circuit (IC) for causing an apparatus to perform a method in accordance with claim 1.

35. A computer program product embodied in a computer-readable medium for causing an apparatus to perform a method in accordance with claim 1.
